(19) United States
(12) Patent Application Publication
(10) Pub. No.: US 2014/0248709 A1
(43) Pub. Date: Sep. 4, 2014

(54) METHODS DEVICES AND SYSTEMS FOR OPTICAL PROBING OF MOLECULAR STRUCTURE AND INTERACTIONS

(71) Applicant: The Trustees of Columbia University in the City of New York, (US)

(72) Inventor: Kenneth B. EISENTHAL, Ridgewood, NJ (US)

(73) Assignee: The Trustees of Columbia University in the City of New York, New York, NY (US)

(21) Appl. No.: 13/724,059

(22) Filed: Dec. 21, 2012

Related U.S. Application Data
(60) Provisional application No. 61/578,608, filed on Dec. 21, 2011.

(51) Int. Cl. G01N 21/75

(52) U.S. Cl. CPC G01N 21/75
USPC 436/501; 422/82.05

(57) ABSTRACT

Non-linear spectroscopic devices, systems, and methods for probing molecules. A non-linear spectroscopic method for probing molecules can include providing a plurality of molecules in an aqueous solution, the providing being effective for permitting the molecules to be free in said aqueous solution and without the molecules being bound to another material such that second harmonic or sum frequency coherent light would result from the illumination of the molecules changes in their conformation. The method can also include probing the molecules by directing light at one or more selected frequencies to generate second harmonic or sum frequency incoherent light resulting from predefined interactions between the first and second molecules and capturing the incoherent light and detecting the same.

### STATEMENT REGARDING FEDERALLY SPONSORED RESEARCH

The present invention was made with government support under grant number CHE-1041980 awarded by the National Science Foundation (NSF). The U.S. government has certain rights in the invention.

### BACKGROUND

Knowledge of equilibrium and time dependent interactions of biomolecules with other biomolecules, e.g. DNA-protein, DNA-DNA hybridization, drug-DNA, etc. and with other small molecules and ions, can be used to develop a molecular level description of biological and biomedical processes. However, many current methods rely on labeling, staining, and/or immobilizing the biomolecules in order to study the kinetics and thermodynamics of such interactions (including Western blotting, or affinity electrophoresis). This perturbs the natural system, may lead to inaccurate measurements, and may also be inconvenient to implement.

The current methods for measuring the strength of a given biomolecule-biomolecule interaction, referred to as their binding constant, include surface plasmon resonance (SPR) and isothermal calorimetry (ITC). The binding constant can quantify the magnitude of the biomolecule-biomolecule interaction and can tell how strongly a drug binds to DNA or a protein. The SPR technique can be complex, expensive, require one of the biomolecules to be covalently bound to a gold surface, which may not properly mimic real biomolecular interactions that occur for free molecules in solution.

The ITC technique is also expensive and requires a 1-2 mg per use. In addition the ITC method does not have the capability to measure time dependent processes, enzyme cleaving DNA, or structural changes in real time. The limiting feature of the fluorescence resonance energy transfer (FRET) method is that it requires the molecule or molecules to be doubly labeled, which can alter a biomolecule's interactions with other ions and molecules. The extent and effect of labeling is very difficult to determine.

### SUMMARY

Methods and systems for generating second harmonic generation, SHG, and incoherent singly or doubly resonant sum frequency generation, SFG for label free measurement of the properties and dynamics of the molecular interaction in a solution environment are described. The methods and systems demonstrate that SHG and SFG can be used to probe molecular interactions without the need for binding any of the interrogated molecules to a surface and without the need for an interface such as gas-fluid interface. Thus, the dynamics and properties of bonding of free species in solution can be investigated and quantified, thus providing information that is relevant to realistic conditions associated with molecular interaction in natural systems such as inside cells and in the blood.

The disclosed subject matter relates to measurement of the affinity constants (bonding strength] of molecules, such as biomolecules, including. DNA RNA, proteins, interacting with other biomolecules and small molecules, e.g. drugs, peptides. In embodiments, a disclosed method employs second harmonic SHG, and sum-frequency generation, SFG, to measure the change in the optical signals that occurs when a biomolecule complexes with another biomolecule. In the method, changes in the net charge of the microparticles on complexation, and changes in the nonlinear hyperpolarizability due to the presence of a new molecule complexed with a bound target molecule produce a change in the SHG/SFG signals. Changes in the second order nonlinear susceptibility cause a change in the detected optical signals. In embodiments, the disclosed subject matter employs a laser, a monochromator, a photomultiplier and a computer to interface the data. The methods and systems described may have advantages over surface Plasmon resonance, calorimetry and nonlinear spectroscopy methods that use surface-bound molecules or interrogate molecules at an interface of different phases or materials.

In embodiments, two participating molecules, such as a biomolecule and a small molecule or two biomolecules, are held separately in solutions and combined in an optical cell while being illuminated with one or more light sources. The SHG and/or SFG signals are collected and directed into one or more monochromators. Filters may be used in place of a monochromator in alternative embodiments. This system and method provide a commercial opportunity in drug design, exploring treatment methodologies, and diagnostic methods at the biomolecular level. The methods may also be used for the development and quality control in non-biological, organic, semiconductor, metals, or biomolecular industrial manufactures for production of chemical species, agents, drugs, nanoparticles, metals, etc. Also, systems, methods, and apparatuses according to various embodiments of the disclosed subject matter can be used, inter alia, for drug discovery, for drug design, to investigate diseases and develop diagnostic methods at the biomolecular level, and for DNA sequencing.

Embodiments will hereinafter be described in detail below with reference to the accompanying drawings, wherein like reference numerals represent like elements. The accompanying drawings have not necessarily been drawn to scale. Where applicable, some features may not be illustrated to assist in the description of underlying features.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Where applicable, some features may not be illustrated to assist in the description of underlying features.

FIG. 1A is a schematic representation of a method or apparatus for inspecting a sample using a light source and generating incoherent second harmonic light shows the sample reveal properties of the sample.

FIG. 1B is a schematic representation of a method or apparatus for inspecting a sample using a light source and generating incoherent sum frequency light shows the sample reveal properties of the sample.

FIG. 2 shows an apparatus for capturing signal information representing properties of molecules in a solution under inspection.

FIG. 3 describes a method according to embodiments of the disclosed subject matter.

### DESCRIPTION

In embodiments, the disclosed methods and systems may be employed to measure the affinity constants of biomolecules interacting with other biomolecules or with small molecules. In prior art systems coherent SHG resulted when complexing of an interface bound molecule with a free molecule from a solution resulted in a substantial change in the net surface charge. The method may be used to quantify biomolecule-biomolecule interactions based on the magnitude of their affinity constant. The magnitude of the affinity constant is of major importance in that it may be used to characterize the strength of the biomolecule-biomolecule interaction. The affinity constant is defined as the dissociation constant of the complex,

Affinity Constant=K_{d}=(B)(M)/(B−M)

where (B) is the concentration of the biomolecule, (M) is the concentration of the molecule with which it complexes, and (B−M) is the concentration of the complex. In SHG the incident light at frequency co-irradiates the system under investigation and can generate coherent light at 2 ω, provided the molecules were oriented and not anisotropic in the medium so that that mutual alignment or symmetry is broken. In the presently disclosed subject matter, this symmetry requirement is broken.

The disclosed subject matter utilizes incoherent singly or doubly resonant second harmonic generation, SHG, and incoherent singly or doubly resonant sum frequency generation, SFG. The disclosed subject matter can utilize spectroscopic methods. Because of this it is possible selectively to probe different molecules in the solution by tuning the frequency of the incident light such that there is an SHG or SFG resonance with the electronic/vibrational spectral frequencies that are characteristic of the molecules of interest. In the disclosed subject matter the light generated is from selected molecules in their natural state in the bulk solution, i.e. at the in vivo temperature, pH, electrolytes, other molecules (organic, inorganic, and biological) and no labels or attachments to solid surfaces are needed.

In embodiments, the second harmonic generation (SHG) systems can employ incident light at a frequency ω₁ to polarize molecules in a solution by illuminating them with a continuous or pulsed beam. As a result of fluctuations in a second order polarization, the molecules may generate incoherent light at 2 ω₁, which can be captured with a photodetector to produce a time-intensity data or an instantaneous intensity sample at a predefined interval after, or at multiple times during or after the illumination. The frequency ω₁ can be tuned such that the SH light at 2 ω₁ is resonant with an electronic transition of the molecules of interest. As such, the one or more light sources may have selectable wavelengths, for example, a tunable laser may be used.

The singly and doubly resonant property can enable identification and differentiation of the various molecules in the solution based on their specific electronic and/or vibrational spectra. The resonance feature of the disclosed subject matter can enhance the optical signal, which can improve detection using a smaller quantity of the biomolecules. The SHG and SFG can operate on picomolar quantities without resonance enhancement. With resonance enhancement, a smaller quantity of biomolecules may be used. The method may include irradiating a solution containing the molecules of interest with laser pulses.

The disclosed subject matter includes methods and systems for analyzing biomolecular interactions which may be used in research, quality control of products, forensic analysis of small quantities of unknown materials, and assays involving biomolecules or inorganic molecules. In embodiments, biomolecular interactions may be probed without the use of molecular labels attached to biomolecules of interest. The time resolution of the systems and methods permit the monitoring of equilibrium and/or time dependent processes in biological and medical systems.

In an SHG method or system, incident light at a frequency ω₁ polarizes the molecules in a solution. Due to fluctuations in the second order polarization, incoherent light at 2 ω₁ is generated which can be monitored with a photodetector. In embodiments, the frequency ω₁ is be selected such that the SH light at 2 ω₁ is resonant with an electronic transition of the molecules of interest.

In SFG method or system, two beams of light at different frequencies are made incident on molecules in solution. The frequencies are selected to be resonant with different electronic transitions of a molecule or complex of interest so that a double electronic resonance is achieved, which is the electronic sum frequency. SFG can increase the second harmonic signal for a single resonance by a factor of 10² and a factor of 10⁴ for a double resonance. As a consequence molecules of interest can be readily differentiated from other molecules because the other molecules only generate a nonresonant, weaker signal.

In the SFG method the incident light contains two beams of light, one light pulse at frequency ω₂ and the other one at a frequency ω₃. The light that is generated and detected is their sum frequency: ω_{SF}=ω₂+ω₃. The frequencies of the incident light can be chosen such that one of them is resonant with an electronic transition in the molecule of interest, and/or the light at the sum frequency, ω_{SF} is resonant with an electronic transition. The frequency of the other light pulse will be chosen such that it is resonant with a vibration in the molecule of interest that is IR and Raman active. Thus we have a double resonance, one with an electronic transition and the other with a vibrational transition. Because this latter method is a nonlinear vibrational spectroscopy, it has the analytical and/or structural sensitivity of linear vibrational spectroscopy. The SFG resonant enhancement factor can go from 10² to a value of 10⁵ for an aromatic chiral molecule.

The incoherent resonance SHG and SFG equipment can include a system that can include a laser, wavelength tuning components, a monochromater, a detector, and/or a digital data processing device for storing and/or analyzing the data. The wavelength tuning components can, for example, have a range of 220 nm-20000 nm. One system can perform one or both tunable SHG and/or SFG measurements. The SHG/SFG system can be useful to laboratories around the world, including but not limited to the pharmaceutical and bio tech industries, research biology and medical laboratories, and/or in industries that create and/or use polymers.

Potential applications of the disclosed subject matter include but are not limited to: label-free spectroscopic probing of molecules in solution, with significant signal to background improvement over conventional spectroscopic methods. The technique may be used to measure directly the conformation of a species as well as its interaction with other species.

The technique may be used to detect conformational change in a molecule upon binding of the molecule to another. The method or system uses one or more light sources to illuminate the molecules with one or more light beams at one or more fundamental frequencies and quantifies incoherent light emanating from the molecules. The molecules may be in a solution at the time of the binding. A change in the light wavelength distribution detected during or after the binding relative to the value in the absence of binding indicates information such as the rate of binding or other property of the binding such as conformational change of one of the molecules associated with the binding or that occurs after binding. In embodiments, the frequency is a combination of the frequencies of the one or more light sources which may include a double frequency of one light source or a sum frequency of two light sources.

The foregoing methods and system may be used for measurement of thermodynamic binding constants as well as kinetic parameters. The foregoing methods and system may be used for detection of binding compounds, for instance in pharmaceutical screening. The foregoing methods and systems may be used for monitoring conformational changes in a compound or biomolecule as a basic research tool or for a biosensor.

According to embodiments, incoherent light form SHG and SFG processes can be captured and measured from very small quantities at picomolar concentrations without resonance enhancement. Even smaller concentrations can be used if resonance enhancement is employed.

In a method, the light sources are selected or tuned for a specific molecule or molecular interaction and selecting one or more filters or monochromator to select a frequency or range of frequencies of SHG or SFG incoherent light and detecting the incoherent light from the sample in the presence of molecules and interactions other than the specific molecule or molecular interaction. In a variation, incoherent light from a distribution of frequencies is detected over a range of said frequencies and stored as a spectral data to allow a target interaction to be selectively analyzed or it time, quantity of bonds, time distribution of interactions, etc. to be extracted from the spectral data.

In the embodiments, the interacting molecules of interest are free in solution, unattached to surfaces or labels. The incoherent light generated upon receiving light from the one or more light sources is from the selected molecules in their natural state in the bulk solution, i.e. at the in vivo temperature, pH, electrolytes, concentration relative to other molecules (organic, inorganic, and biological), without interference from labels or attachments to solid surfaces.

The foregoing descriptions apply, in some cases, to examples generated in a laboratory, but these examples can be extended to production techniques. For example, where quantities and techniques apply to the laboratory examples, they should not be understood as limiting.

Features of the disclosed embodiments may be combined, rearranged, omitted, etc., within the scope of the invention to produce additional embodiments. Furthermore, certain features may sometimes be used to advantage without a corresponding use of other features. It is, thus, apparent that there is provided, in accordance with the present disclosure, methods, devices, and systems for probing molecular structure and interactions. Many alternatives, modifications, and variations are enabled by the present disclosure. While specific embodiments have been shown and described in detail to illustrate the application of the principles of the invention, it will be understood that the invention may be embodied otherwise without departing from such principles. Accordingly, Applicants intend to embrace all such alternatives, modifications, equivalents, and variations that are within the spirit and scope of the present invention.

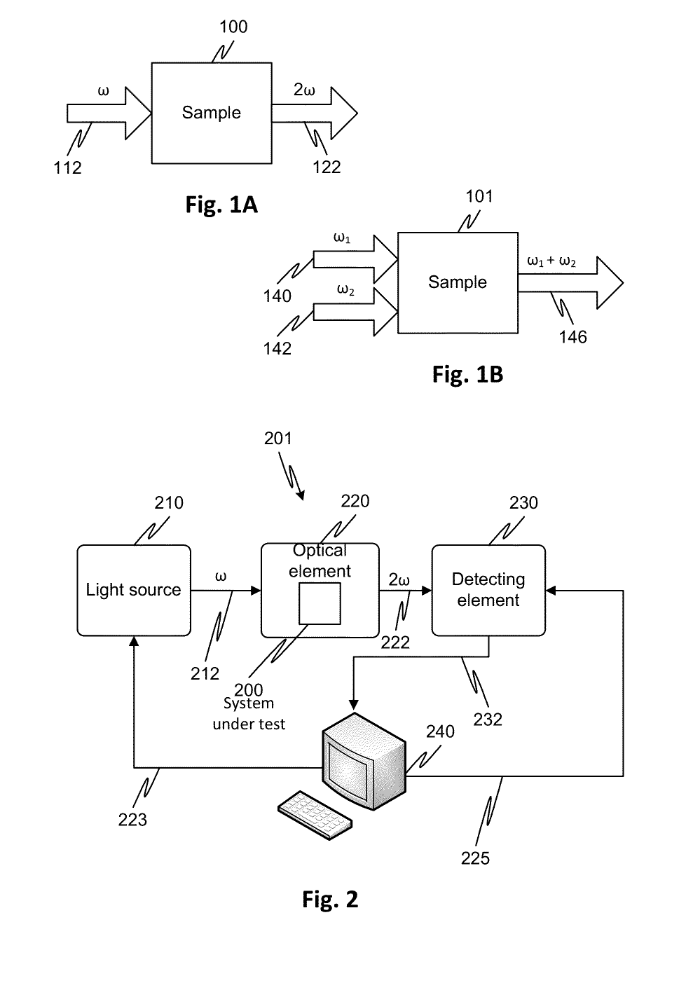

FIG. 1A is a block diagram of a sample 100 that is inspected by light 112 from a light source at a selected frequency or frequency distribution ω. The light 112 at frequency or frequency distribution ω is directed at the sample 100 and incoherent light 122 from the sample is output, which includes a component of frequency 2 ω as a result of SHG arising from interaction of molecules in the sample 100. The sample 100 contains free target molecules in solution which have been combined, or are progressively combined during an evaluation run. In embodiments the free molecules include multiple species that interact to form complexes or which bond covalently producing a SHG in the range or at frequency or range ω. By “free” it is meant that the molecules that interact are not bound and therefore that mutual alignment or symmetry of the molecular structures is not present in the system under test.

FIG. 1B is a block diagram of a sample 101 that is inspected by light 140, 142 from light sources at multiple selected frequencies, or ranges containing frequencies, for example two frequencies ω₁ and ω₂. The light 140 is directed at the sample 101 and incoherent light from the sample is output, which includes a component of frequency ω₁+ω₂ resulting from SFG arising from the interaction of the molecules in the sample 101. The sample 101 contains free target molecules in solution which have been combined, or are progressively combined during an evaluation run. In embodiments the free molecules include multiple species that interact to form complexes or which bond covalently producing a SHG in the range or at frequency or range ω. By “free” it is meant that the molecules that interact are not bound and therefore that mutual alignment or symmetry of the molecular structures is not present in the system under test.

In either of embodiments 1A and 1B, the sample under inspection may be a single molecular species. In an example test, a predicted SHG or SFG signal may be expected by theory or previous evidence, and the configuration of FIG. 1A or 1B used to verify the prediction or expectation. For example, a product from a chemical production plant may potentially contain an unwanted species that can be characterized by a SHG or SFG signature.

In addition, either of embodiments 1A and 1B can be used to determine a maximum number of molecule-molecule bonds formed, or that can form, selectively probe a specific molecular interaction in the presence of at least one other different molecular interaction, detect trace amounts of a target substance, or time-resolve the interaction of different molecules in a solution or a single molecule in an environment that is instantly changed. Also, the frequency ranges applied and detected may be progressively changed while receiving SH or SF radiation and the result used to determine affinity constants of species that are combined in the sample. In either of embodiments 1A and 1B, the light 112, 140, 142 may be continuous or pulsed. Varying the frequency of the output signal may be used to determine a maximum or optimal frequency at which to radiate a given molecule or combination or molecules by identifying peaks in the target SH signal. By scanning over a range of illuminating frequencies and recording SH signals, the presence and concentration of diverse complexes may be identified and quantified.

Referring to FIG. 2, an inspection apparatus 201 includes one or more light sources represented schematically at 210. The one or more light sources may include one or more lasers, such as a tunable laser (e.g., Ti-sapphire laser). Light source(s) 210 may output light 212 at one or more frequencies or may progressively vary the frequency or frequencies. Light output 212 is directed toward optical element 220 to probe a system under test 200 using SHG. The system under test 200 may be a reaction vessel, a jet, a microfluidic channel or chamber, or any other support system capable of permitting light to pass in and out of a solution containing one or more molecules of interest. An optical element 220 may include any suitable optical element or elements to direct light into and from the system under test 200 to allow for the described inspection of molecular interaction. The system under test 200 can be staged for testing by any suitable means, such as a stage, an enclosure (e.g., a test tube, beaker, or other glass enclosure), etc.

Detecting element 230 may include a spectrometer or a combination of either of a monochromator or other chromatic filter with a photomultiplier or other photodetector. Generally speaking, a spectrometer may include any optical device for producing and observing a spectrum of light or radiation from a source. A monochromator or monochromatic illuminator may include a spectroscope with a slit that can be moved across a spectrum for viewing individual spectral bands. Alternatively, a filter may be used instead of a monochromator or a monochromatic illuminator according to know spectral techniques.

Optical element 220 can contain the system under test 200, or, alternatively, the system under test 200 can be coupled to, or adjacent, optical element 220. In any case, optical element 120 can be arranged or positioned to facilitate nonlinear spectroscopy on the system under test 200, such as second SHG or sum-frequency generation, in order to probe the system under test 200. In various embodiments, optical element 220 can reject all light that is not at the SHG frequency of 2 ω.

Detecting element 230 can be of any suitable configuration that provides for capture and quantification of light in the selected frequency range, for example, at or about the predicted or experimentally identified SH signal frequency. For example, detecting element 230 may constitute a single-photon detection electronics such as a photomultiplier. Detecting element 230 receives at least a 2 ω signal 222 from the optical element 220 and outputs a corresponding signal 232 to processing element 240. Optionally, detecting element 230 can detect a first order mechanism and/or sense a third order mechanism due to charge effects on the bulk water as discussed above. Detection of this third order mechanism may be used to increase sensitivity regarding changes in the SHG signal. Alternatively, a separate detecting or sensing element may be provided to sense or detect the third order mechanism. Signal 232, responsive to, or embodying, the signal 222 can also be sent directly to a computer storage medium. Optionally, processing element 240 may process and analyze the signal 232 and output the data to the computer storage medium and/or an output component, such as a display device or processor and display device.

Processing element 240 can be any suitable mechanism that uses or further processes the SH information, such as an embedded system, desktop computer, a microprocessor, a PDA, a laptop computer, etc. Further, processing element 240 can be coupled to an output component (not shown) configured for outputting results of calculations performed by the processing element, such as a display or a link to a wireless terminal.

Processing element 240 can include or be coupled to a memory element to store data. Thus, data representative of the signal or signals received from detecting element 130 can be stored in the memory element. Processing element 240 may be configured to compare stored data from the memory element with data received from detecting element 230. For example, data from other known techniques, such as SPR or ITC, can be stored in the memory element and compared to data received from detecting element 230. As another example, data or information from previous, for example a solution pre-complexation may be stored in the memory element and compared with data received from detecting element 130. In various embodiments, such comparing can be used as part of an optimization sequence for optimizing sensitivity and/or accuracy for the SHG signals.

Detecting element 230 may include imaging optics that allow light from different angular directions to be discriminated. For example, if a solution under inspection is contained in a vessel in which different parts contain different concentrations of molecular species, the position in the vessel from the incoherent light emanates provides an indication of a relationship between concentration and the molecular presence or interaction revealed by the relevant incoherent light.

As indicated by arrows 223 and 225, processing element 240 may be configured to control detecting element 230 and/or light source(s) 210, to form variations of the embodiments. In an example, the processing element 240 may control the timing of the generation of light from the light source 210 and the timing of the sampling of a signal representing the incoherent light captured from the sample. In another example, the processor element 240 may vary the frequency or frequencies output by the light source or sources over a programmed range or ranges to capture and detect incoherent light from the sample over the corresponding range or ranges.

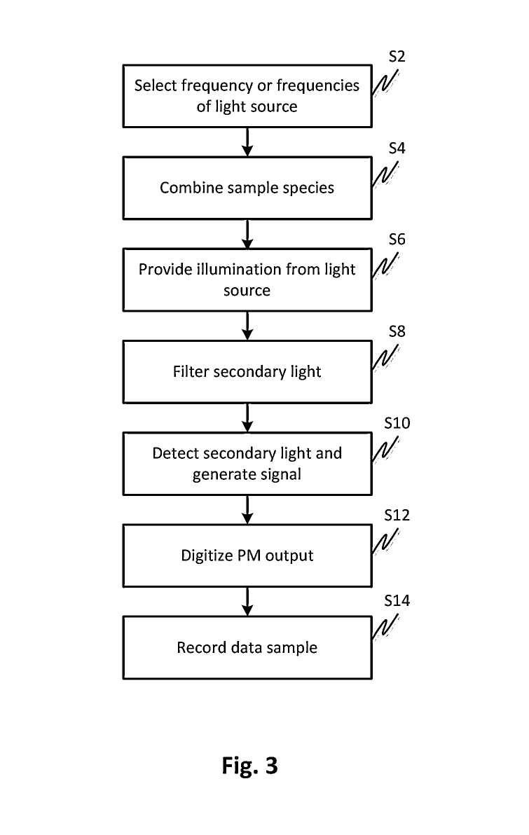

FIG. 3 describes a general method embodiment for generating incoherent from a sample under inspection and capturing and reducing data derived from the incoherent light signal. Referring now to FIG. 3, at S2 one or more selected frequencies or range or ranges of selected frequencies are identified which based on the species to be inspected and based on the expectation of producing SHG of SFG incoherent light output for a sample under inspection. At S4, if applicable, separate species may be instantly or progressively combined. Alternatively a single species is provided to an inspection apparatus such as system 200. Noteworthy at S4 is that none of the species under inspection is bound to or located at a surface or oriented by an interface, except perhaps adventitiously, so that the species are predominantly unoriented and alignment or symmetry of the major fraction of the molecules under inspection is not present. Afterward or simultaneously with S4, at S6 the sample is illuminated by the light source to generate incoherent light from the sample. At S8, SHG or SFG incoherent light may be directed by the optical element and filtered, for example, by monochromator, spectrometer or other filter. At S10, the SHG or SFG light, which may be filtered, is detected by a photodetector to generate a signal that is digitized at S12 and recorded. The signal may be time-resolved or frequency-resolved, for example. The data may then be reduced by a processing element 240 to provide information of interest about the target species according to a variety of published methods as identified herein.

With regard to the processing element 240, it will be appreciated that the modules, processes, systems, and sections described above can be implemented in hardware, hardware programmed by software, software instruction stored on a non-transitory computer readable medium or a combination of the above. For example, a method for probing molecular structures can be implemented, for example, using a processor configured to execute a sequence of programmed instructions stored on a non-transitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and sections can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the method, system, or a computer program product (software program stored on a non-transitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of digital control and data acquisition systems for laboratories and/or computer programming arts.

Moreover, embodiments of the disclosed method, system, and computer program product can be implemented in software executed on a programmed general purpose computer, a special purpose computer, a microprocessor, or the like.

According to embodiments, the disclosed subject matter includes a spectroscopic method for probing molecules that includes providing target molecules having the potential to bind and thereby form electronic and/or vibrational resonances upon illumination by light at one or more selected frequencies. The method further includes combining the target molecules free in a solution without being attached to a surface of a material, including permitting binding pairs of the molecules to bind and such that mutual alignment of interfaces between binding pairs of the target molecules is not present. The method further includes irradiating the target molecules at one or more of the one or more selected frequencies and filtering incoherent light resulting from said irradiating, the filtering being effective to attenuate light components of said incoherent light at frequencies outside one or more selected bands. In one variation of the method, the one or more selected frequencies includes one frequency and the one or more selected bands include a second harmonic of the one frequency. In another variation of the method, the one or more selected frequencies includes two frequencies and the one or more selected bands include a sum frequency of the two frequencies. Finally, in both variations of the method, a filtered result of the filtering is detected and a signal responsively to the detecting is generated that represents properties of the bonds formed by the target molecules in said combining and generating data representing the properties of the bonds formed by the target molecules responsively to the signal.

The foregoing method alternatives may be further modified such that the irradiating includes directing a laser at a sample cell containing the solution. The solution may be devoid of solid particles. In any of the methods, there may be no orienting mechanism for the target molecules so that the only molecules that end up producing a signal are those that arise randomly due to the finite number molecules and the concomitant finite number of orientations, which may thus produce a net polarization and thereby allow the SHG or SFG light to be emitted.

In other variations, the one or more selected frequencies may be effective for producing second harmonic of sum frequency generation resonance with an electronic or vibrational transition of the target molecules or a complexation thereof.

According to embodiments, the disclosed subject matter includes a non-linear spectroscopic method for probing interacting molecules includes providing a plurality of first molecules in an aqueous solution and adding second molecules to the aqueous solution to permit the first and second molecules to interact. The providing and adding are effective for permitting the first and second molecules to be free in said aqueous solution and without either the first or second molecules being further bound to another material such that second harmonic or sum frequency coherent light would result from the illumination of either the first or second molecules or their combination resulting from complexation or bonding. The method further includes probing the first and second molecules interacting in the aqueous solution by directing light at one or more selected frequencies to generate second harmonic or sum frequency incoherent light resulting from predefined interactions between the first and second molecules and capturing the incoherent light and detecting the same.

The directing may include directing light from a pulsed laser at the molecules. The method may include tuning a light source to generate said light at one or more selected frequencies.

According to embodiments, the disclosed subject matter includes a non-linear spectroscopic method for probing molecules including providing a plurality of molecules in an aqueous solution. The providing may be effective for permitting the molecules to be free in said aqueous solution and without the molecules being bound to another material such that second harmonic or sum frequency coherent light would result from the illumination of the molecules changes in their conformation. The method includes probing the molecules by directing light at one or more selected frequencies to generate second harmonic or sum frequency incoherent light resulting from predefined interactions between the first and second molecules and capturing the incoherent light and detecting the same. The directing may include directing light from a pulsed laser at the molecules. The method may further include tuning a light source to generate said light at one or more selected frequencies.

According to embodiments, the disclosed subject matter includes apparatus for inspecting molecules or molecular interactions including a tunable light source adapted for generating light over a range of 220 nm-20000 nm. A support vessel holds a solution. An optical element is adapted for directing light from the tunable light source to the support vessel thereby to illuminate contents thereof. A detector is adapted for detecting incoherent light emitted from said support vessel. A digital data processing element is connected to the detector and adapted for storing and/or reducing data represented in a signal therefrom.

According to embodiments, the disclosed subject matter includes a method of inspecting molecules in solution that uses the following apparatus. The apparatus has a tunable light source adapted for generating light over a range of 220 nm-20000 nm, a support vessel that holds a solution. An optical element is adapted for directing light from the tunable light source to the support vessel thereby to illuminate contents thereof. A detector is adapted for detecting incoherent light emitted from said support vessel. A digital data processing element is connected to the detector and adapted for storing and/or reducing data represented in a signal therefrom. The method using the foregoing apparatus includes tuning the tunable light source to emit a frequency such that there is a SHG or SFG resonance with the electronic/vibrational spectral frequencies that are characteristic of a molecule or molecules of interest and held in said support vessel.

The method can also include using the tunable light source, emitting light in pulses such that the emitted light polarizes molecules in the vessel to generate incoherent light at twice the characteristic frequencies. The method can also include using said tunable light source, emitting light at respective frequencies that are resonant with respective electronic transitions of a molecule held in said support vessel such that a double electronic resonance is achieved, and using the detector, detecting incoherent light resulting from said double electronic resonance.

It is, thus, apparent that there is provided, in accordance with the present disclosure, methods, devices, and systems for probing molecular structure and interactions. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

What is claimed is:

1. A spectroscopic method for probing molecules, the method comprising:
providing target molecules having the potential to bind and thereby form electronic and/or vibrational resonances upon illumination by light at one or more selected frequencies;
combining the target molecules free in a solution without being attached to a surface of a material, including permitting binding pairs of the molecules to bind and such that mutual alignment of interfaces between binding pairs of the target molecules is not present;
irradiating the target molecules at one or more of the one or more selected frequencies;
filtering incoherent light resulting from said irradiating, the filtering being effective to attenuate light components of said incoherent light at frequencies outside one or more selected bands, wherein:
the one or more selected frequencies includes one frequency and the one or more selected bands include a second harmonic of the one frequency; or
the one or more selected frequencies includes two frequencies and the one or more selected bands include a sum frequency of the two frequencies;
detecting a filtered result of the filtering, generating a signal responsively to the detecting that represents properties of the bonds formed by the target molecules in said combining and generating data representing the properties of the bonds formed by the target molecules responsively to the signal.

2. The method of claim 1, wherein the irradiating includes directing a laser at a sample cell containing the solution.

3. The method of claim 1, wherein the solution is devoid of solid particles.

4. The method of claim 1, wherein the one or more selected frequencies are effective for producing second harmonic of sum frequency generation resonance with an electronic or vibrational transition of the target molecules or a complexation thereof.

5. The method of claim 1, wherein the one or more selected frequencies are effective for producing second harmonic of sum frequency generation resonance with an electronic transition of the target molecules or a complexation thereof.

6. The method of claim 1, wherein the one or more selected frequencies are effective for producing second harmonic of sum frequency generation resonance with a vibrational transition of the target molecules or a complexation thereof.

7. A non-linear spectroscopic method for probing interacting molecules, comprising:
providing a plurality of first molecules in an aqueous solution;
adding second molecules to the aqueous solution to permit the first and second molecules to interact;
the providing and adding being effective for permitting the first and second molecules to be free in said aqueous solution and without either the first or second molecules being further bound to another material such that second harmonic or sum frequency coherent light would result from the illumination of either the first or second molecules or their combination resulting from complexation or bonding; and
probing the first and second molecules interacting in the aqueous solution by directing light at one or more selected frequencies to generate second harmonic or sum frequency incoherent light resulting from predefined interactions between the first and second molecules and capturing the incoherent light and detecting the same.

8. The method of claim 7, wherein the directing includes directing light from a pulsed laser at the molecules.

9. The method of claim 7, further comprising tuning a light source to generate said light at one or more selected frequencies.

10. A non-linear spectroscopic method for probing molecules, comprising:
providing a plurality of molecules in an aqueous solution;
the providing being effective for permitting the molecules to be free in said aqueous solution and without the molecules being bound to another material such that second harmonic or sum frequency coherent light would result from the illumination of the molecules changes in their conformation; and
probing the molecules by directing light at one or more selected frequencies to generate second harmonic or sum frequency incoherent light resulting from predefined interactions between the first and second molecules and capturing the incoherent light and detecting the same.

11. The method of claim 10, wherein the directing includes directing light from a pulsed laser at the molecules.

12. The method of claim 10, further comprising tuning a light source to generate said light at one or more selected frequencies.

13. Apparatus for inspecting molecules or molecular interactions, comprising:
a tunable light source adapted for generating light over a range of 220 nm-20000 nm;
a support vessel for holing a solution;
an optical element adapted for directing light from the tunable light source to the support vessel thereby to illuminate contents thereof;
a detector adapted for detecting incoherent light emitted from said support vessel;
digital data processing element connected to the detector and adapted for storing and/or reducing data represented in a signal therefrom.

14. A method of inspecting molecules in solution, comprising:
providing an apparatus having:
a tunable light source adapted for generating light over a range of 220 nm-20000 nm;
a support vessel for holing a solution;
an optical element adapted for directing light from the tunable light source to the support vessel thereby to illuminate contents thereof;
a detector adapted for detecting incoherent light emitted from said support vessel;
digital data processing element connected to the detector and adapted for storing and/or reducing data represented in a signal therefrom;
tuning the tunable light source to emit a frequency such that there is a SHG or SFG resonance with the electronic/vibrational spectral frequencies that are characteristic of a molecule or molecules of interest and held in said support vessel.

15. The method of claim 14, further comprising, using said tunable light source, emitting light in pulses such that the emitted light polarizes molecules in the vessel to generate incoherent light at twice the characteristic frequencies.

16. The method of claim 14, further comprising, using said tunable light source, emitting light at respective frequencies that are resonant with respective electronic transitions of a molecule held in said support vessel such that a double electronic resonance is achieved, and using the detector, detecting incoherent light resulting from said double electronic resonance.
